(19) United States
(12) Patent Application Publication
(10) Pub. No.: US 2018/0065180 A1
(43) Pub. Date: Mar. 8, 2018

(54) ADDITIVE MANUFACTURING APPARATUS AND ADDITIVE MANUFACTURING METHOD

(71) Applicant: KABUSHIKI KAISHA TOSHIBA, Minato-ku (JP)

(72) Inventors: Morihiro MACHIDA, Chuo (JP); Hideshi NAKANO, Yokosuka (JP); Hiroshi OHNO, Yokohama (JP); Kazunari IWAKAWA, Kawasaki (JP); Aya WATASE, Kawasaki (JP)

(73) Assignee: KABUSHIKI KAISHA TOSHIBA, Minato-ku (JP)

(21) Appl. No.: 15/557,633

(22) PCT Filed: Sep. 14, 2015
(86) PCT No.: PCT/JP2015/076045

§ 371 Date: Sep. 12, 2017

(30) Foreign Application Priority Data
Mar. 18, 2015 (JP) 2015-055182

(51) Int. Cl. B22F 3/105; B29C 64/209; B29C 64/245

(52) U.S. Cl. CPC B22F 3/105; B29C 64/209; B22F 2003/1042; B22F 2003/1056; B29C 64/245

(57) ABSTRACT

An additive manufacturing apparatus includes a first stage, a second stage, and a nozzle. The first stage includes a first face. The second stage includes a second face. The nozzle forms a layer of a material on at least one of the first face, the second face, an object on the first face, and an object on the second face, while the first face and the second face are oriented in mutually different directions.

### FIELD

Embodiments of the present invention relate to an additive manufacturing apparatus and an additive manufacturing method.

### BACKGROUND

Conventionally, there has been known additive manufacturing apparatuses which additively manufacture objects. An additive manufacturing apparatus supplies a powder material from a nozzle while emitting laser light thereto to melt the material and form layers of the material for additively manufacturing an object.

### CITATION LIST

### Patent Literature

Patent Literature 1: Japanese Patent Application Laid-open No. 2003-071940 A

Patent Literature 2: Japanese Patent Application Laid-open No. 2014-113759 A

Patent Literature 3: Japanese Patent Application Laid-open No. 05-024119 A

### SUMMARY OF THE INVENTION

### Problem to be Solved by the Invention

It is useful to provide such an apparatus which can efficiently form layers of materials, for example.

### Means for Solving Problem

An additive manufacturing apparatus according to the embodiment comprises a first stage, a second stage, and a nozzle. The first stage includes a first face. The second stage includes a second face. The nozzle forms a layer of a material on at least one of the first face, the second face, an object on the first face, and an object on the second face, while the first face and the second face are oriented in mutually different directions.

### BRIEF DESCRIPTION OF DRAWINGS

FIG. 1 is a schematic diagram of an additive manufacturing apparatus according to a first embodiment.

FIG. 2 is a partial cross-sectional view of a nozzle according to the first embodiment.

FIG. 3 is diagram illustrating an exemplary additive manufacturing process for an object by the additive manufacturing apparatus according to the first embodiment.

FIG. 4 is a diagram illustrating a part of the additive manufacturing apparatus according to the first embodiment, in which stages are parallel with each other.

FIG. 5 is a diagram illustrating a part of the additive manufacturing apparatus according to the first embodiment, in which the stages are oriented in mutually different directions.

FIG. 6 is a diagram illustrating a part of the additive manufacturing apparatus according to the first embodiment, in which objects are integrated with each other on the stages oriented in the different directions.

FIG. 7 is a diagram illustrating the formation of an object on one stage of the additive manufacturing apparatus according to the first embodiment.

FIG. 8 is a diagram illustrating the formation of objects on two stages of the additive manufacturing apparatus according to the first embodiment.

FIG. 9 is a diagram illustrating the formation of objects on the two stages of the additive manufacturing apparatus according to the first embodiment.

FIG. 10 is a diagram illustrating a part of an additive manufacturing apparatus according to a second embodiment.

FIG. 11 is a diagram illustrating a part of the additive manufacturing apparatus according to the second embodiment, in which the stages are swung to one side.

FIG. 12 is a diagram illustrating a part of the additive manufacturing apparatus according to the second embodiment, in which two stages are pushed up with respect to one stage.

FIG. 13 is a diagram illustrating a part of the additive manufacturing apparatus according to the second embodiment, in which objects formed on the individual stages are integrated with each other.

### DETAILED DESCRIPTION

Hereinafter, embodiments will be described in detail with reference to the accompanying drawings. The following embodiments include similar or same components, and they are denoted by common reference numerals, and an overlapping description thereof will be omitted.

### First Embodiment

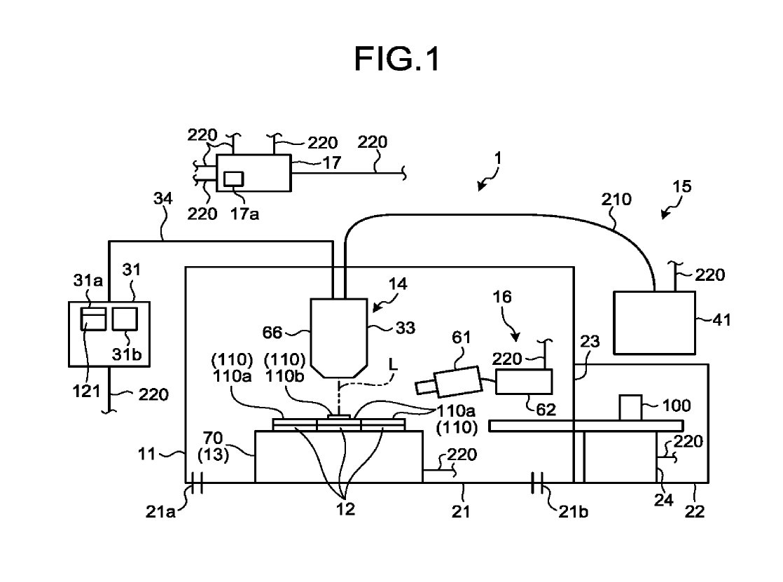

As illustrated in FIG. 1, an additive manufacturing apparatus 1 includes a treatment tank 11, a stage 12, a mover 13, a nozzle unit 14, an optical unit 15, a measurement unit 16, and a control unit 17.

The additive manufacturing apparatus 1 additively manufactures an object 100 having a predetermined shape by adding a layer upon a layer of a material 121 supplied from the nozzle unit 14 onto an intended object 110 placed on the stage 12. Herein, an object 101 is formed of one or more layers 110b.

The intended object 110 is a target to which the material 121 is supplied from the nozzle unit 14, and includes a base 110a and layers 110b. The layers 110b are added on the top face of the base 110a. The material 121 is a powdery metal material or a powdery resin material, for example. One or more materials 121 can be used for manufacturing.

The treatment tank 11 includes a main chamber 21 and a sub chamber 22. The sub chamber 22 is adjacent to the main chamber 21. A door 23 is provided between the main chamber 21 and the sub chamber 22. While the door 23 is open, the main chamber 21 and the sub chamber 22 are communicated with each other. When the door 23 is closed, the main chamber 21 becomes airtight.

The main chamber 21 includes a supply port 21a and a vent 21b. An inert gas such as nitrogen or argon is supplied into the main chamber 21 via the supply port 21a by operation of a gas supplier (not illustrated). The gas is discharged from the main chamber 21 via the vent 21b by the operation of an exhaust device (not illustrated).

The main chamber 21 includes a transfer unit (not illustrated) and a conveyer 24 extending from the main chamber 21 to the sub chamber 22. The transfer unit transfers the processed object 100 from the main chamber 21 to the conveyer 24. The conveyer 24 conveys the object 100 transferred from the transfer unit into the sub chamber 22. That is, the sub chamber 22 accommodates the object 100 processed in the main chamber 21. After the object 100 is accommodated in the sub chamber 22, the door 23 is closed to isolate the sub chamber 22 and the main chamber 21 from each other.

The main chamber 21 includes the stage 12, the mover 13, a part of the nozzle unit 14, and the measurement unit 16.

The stage 12 supports the object 110. The mover 13 can move the stage 12.

The nozzle unit 14 supplies the material 121 to the object 110 on the stage 12. A nozzle 33 of the nozzle unit 14 emits laser light L to the object 110 on the stage 12. The nozzle unit 14 can supply multiple materials 121 in parallel, and also selectively supply one of the materials 121. The nozzle 33 emits the laser light L while supplying the material 121.

The nozzle unit 14 includes a supply unit 31, the nozzle 33, and a supply pipe 34. The material is supplied from the supplier 31 to the nozzle 33 via the supply pipe 34.

The supply unit 31 includes a tank 31a and a supplier 31b. The tank 31a accommodates the material 121. The supplier 31b supplies a predetermined amount of the material 121 from the tank 31a. The supply unit 31 supplies a carrier gas (gas) containing the powdered material 121. The carrier gas is an inert gas such as nitrogen or argon, for example.

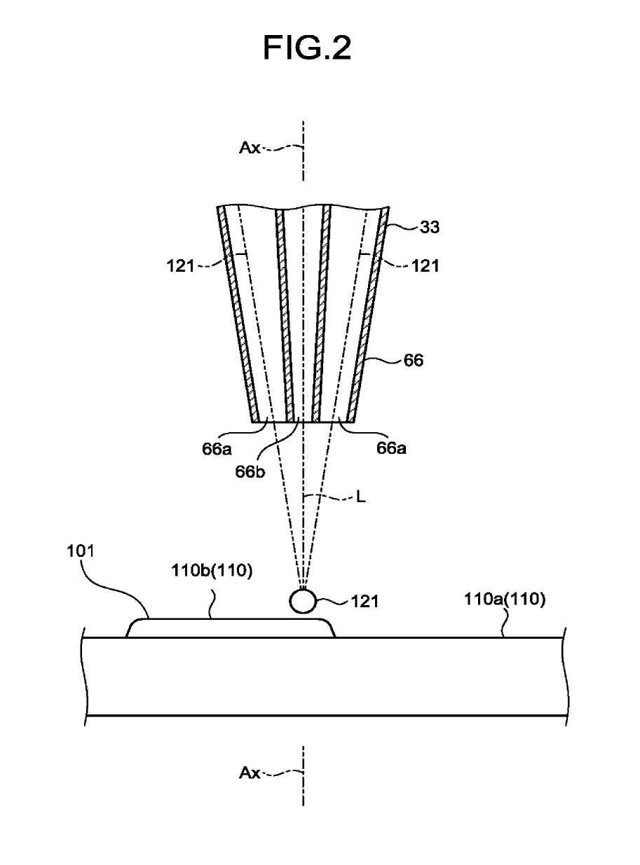

As illustrated in FIG. 2, the nozzle 33 includes a housing 66. The housing 66 has a cylindrical shape. As illustrated in FIG. 2, the housing 66 includes passages 66a and one passage 66b inside.

The passage 66b coincides with an axis Ax of the housing 66. The laser light L is introduced into the passage 66b from the optical unit 15. The passage 66b internally includes an optical system including a convertor lens that converts the laser light L into parallel light and a lens that condenses the parallel laser light L. The laser light L is condensed by the lens on a point below the housing 66. A focal point (convergence point) of the laser light L is located on the axis Ax.

Each of the passages 66a is connected to the supply unit 31 via the supply pipe 34. When the material 121 is powder, the material 121 is supplied together with the carrier gas from the supply unit 31 to each of the passages 66a. The bottom of the passage 66a is inclined downward with respect to the axis Ax, approaching the axis Ax of the housing 66.

When the material 121 is powder, the nozzle 33 blasts (injects) the material 121 from the bottom end (opening) of the passage 66a to a point below the housing 66 (passage 66a). Alternatively, when the material 121 is linear, the nozzle 33 extrudes (injects) the material 121 from the bottom end (opening) of the passage 66a to a point below the housing 66 (passage 66a). The blasted or extruded material 121 reaches the convergence point of the laser light L. The material 121 supplied by the nozzle 33 is melted by the laser light L and becomes a mass of the molten material 121. The material 121 may be sintered by the laser light L.

As illustrated in FIG. 1, the optical unit 15 includes a light source 41 and a cable 210. The light source 41 includes an oscillation element (not illustrated) that oscillates to emit the laser light L. The light source 41 can change power density of the laser light to emit.

The light source 41 is connected to the nozzle 33 via the cable 210. The laser light L emitted from the light source 41 is guided to the nozzle 33. The nozzle 33 emits the laser light L to the object 110 and the material 121 blasted to the object 110.

The measurement unit 16 measures a shape of the solidified layer 110b and a shape of a manufactured object 100. The measurement unit 16 transmits information on the measured shape to the control unit 17. The measurement unit 16 includes, for example, a camera 61 and an image processor 62. The image processor 62 processes images on the basis of the information measured by the camera 61. The measurement unit 16 measures the shape of the layer 110b and the manufactured object 100 by, for example, an interference method or an optical cutting method.

The control unit 17 is electrically connected to the mover 13, the conveyer 24, the supply unit 31, the light source 41, and the image processor 62 via signal lines 220.

The control unit 17 controls the mover 13 to move the stage 12. The control unit 17 controls the conveyer 24 to convey the object 100 to the sub chamber 22. The control unit 17 controls the supply unit 31 to supply or non-supply the material 121 and adjust the amount of the supply. The control device 17 controls the light source 41 to adjust the power density of the laser light L to emit from the light source 41. The control unit 17 controls the movement of the nozzle 33.

The control unit 17 includes a storage 17a. The storage 17a stores data indicating the ratio of the material 121 and data indicating the shape (reference shape) of the object 100 to manufacture.

The control unit 17 can include a function of selectively supplying different materials 121 from the nozzle 33 and adjusting (changing) the ratio of the materials 121. For example, the control unit 17 controls the supply unit 31 and other units to form the layers 110b of the material 121 at the ratio indicated by the data containing the ratio of the materials 121 stored in the storage 17a. By this function, it is made possible to form a gradient material (functionally graded material) which changes (gradually decreases or gradually increases) in the ratio of the materials 121 depending on the position (location) of the object 100. Specifically, for example, for the formation of the layers 110b, the control unit 17 controls the supply unit 31 to supply the materials 121 at the set (stored) ratio for each of the positions in a three-dimensional coordinates of the object 100, making it possible to manufacture the object 100 as a gradient material (functionally graded material) which changes in the ratio of the materials 121 in any three-dimensional direction. It is also possible to set the change amount (change rate) of the ratio of the materials 121 per unit length in various manners.

The control unit 17 includes a function of determining the shape of the material 121. For example, the control unit 17 determines whether the layer 110b or the object 100 includes a region of an unintended shape by comparing the shape of the layer 110b or the object 100 measured by the measurement unit 16 with the reference shape stored in the storage 17a.

The control unit 17 further includes a trimming function of removing an unnecessary region, determined as having an unintended shape, from the material 121 to form an intended shape. For example, in a case where the material 121 scatters and adheres to a different region from the intended shape, the control unit 17 controls the light source 41 to emit the laser light L with the power density to be able to evaporate the material 121. Next, the control unit 17 emits the laser light L to the region and evaporates the material 121.

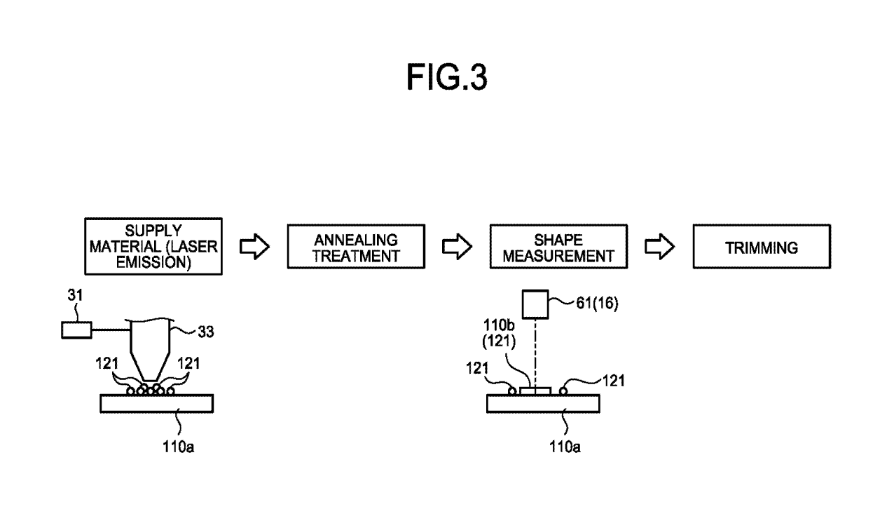

Next, an additive manufacturing method for the object 100 by the additive manufacturing apparatus 1 will be described with reference to FIG. 3. First, as illustrated in FIG. 3, the material 121 is supplied and the laser light L is emitted. The control unit 17 controls the supply unit 31 to supply the material 121 to a predetermined area from the nozzle 33 and controls the light source 41 to melt the supplied material 121 with the laser light L. Thereby, as illustrated in FIG. 3, a predetermined amount of the molten material 121 is supplied to the area i.e., the layer 110b on the base 110a. Having been blasted onto the base 110a or the layer 110b, the material 121 is deformed into a mass of the materials 121, in a form of layer or thin film. Alternatively, the material 121 is layered in granular form to become a mass of powder when cooled by a carrier gas carrying the material 121 or cooled by heat transfer to the mass of materials 121.

Next, annealing treatment is performed.

Annealing treatment may be performed with an annealing device (not illustrated) outside the additive manufacturing apparatus 1, or may be performed inside the additive manufacturing apparatus 1. In the latter, the control unit 17 controls the light source 41 to emit the laser light L to the mass of the materials 121 on the base 110a. Thereby, the mass of the material 121 is remelted into the layer 110b.

Next, shape measurement is performed. The control unit 17 controls the measurement unit 16 so as to measure the material 121 on the base 110a, which has undergone the annealing treatment. The control unit 17 compares the shape of the layer 110b or the object 100 measured by the measurement unit 16 with the reference shape stored in the storage 17a.

Next, trimming is performed. Trimming may be performed with a trimming device (not illustrated) outside the additive manufacturing apparatus 1, or may be performed inside the additive manufacturing apparatus 1. In the latter, when determining from the shape measurement and the comparison with the reference shape that the material 121 is adhered to a different position from the intended shape on the base 110a, for example, the control unit 17 controls the light source 41 to evaporate an unneeded material 121. Meanwhile, the control unit 17 does not perform trimming when determining from the shape measurement and the comparison with the reference shape that the layer 110b has the intended shape.

Upon completion of the formation of the layer 110b as above, the additive manufacturing apparatus 1 forms a new layer 110b on the existing layer 110b. The additive manufacturing apparatus 1 manufactures the object 100 by repeatedly adding the layers 110b.

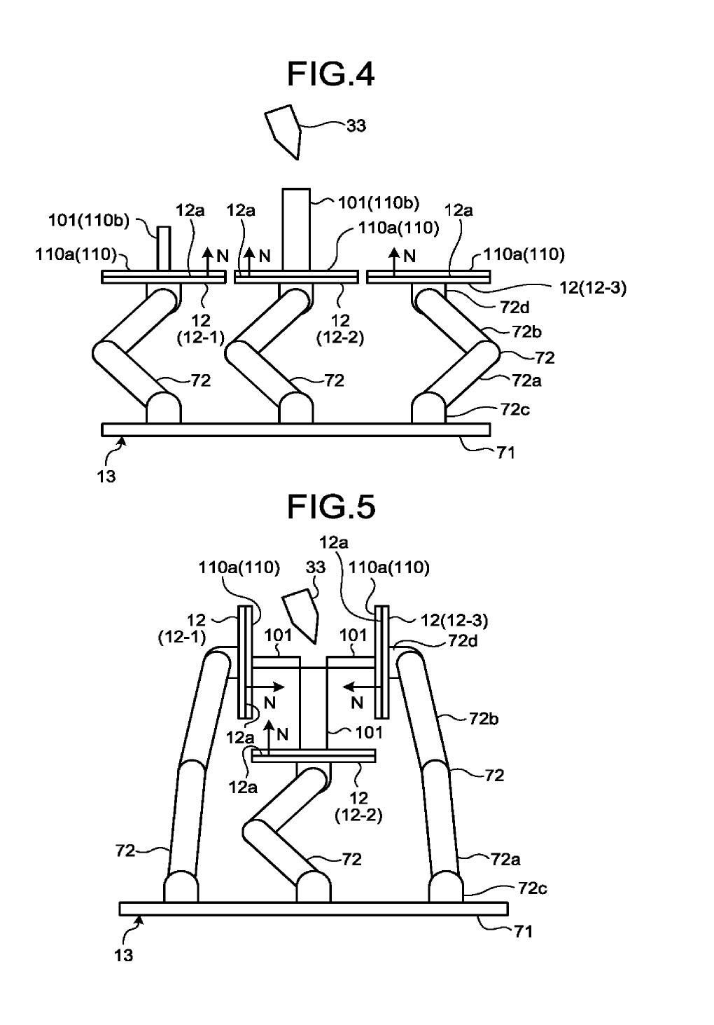

Next, the stage 12 and the mover 13 will be described in detail. As illustrated in FIG. 4, the additive manufacturing apparatus 1 according to the present embodiment includes a plurality of (three, for example) stages 12. The stages 12 include stages 12-1, 12-2, and 12-3. Each of the stages 12 has a flat face 12a (face to be layer-added). The base 110a is provided on each face 12a, and the layers 110b are added on the base 110a. That is, the layers 110b are added on the face 12a. One of the stages 12 corresponds to a first stage, and the rest of the stages 12 correspond to a second stage. According to the present embodiment, the stage 12-2 is an example of the first stage, and each of the stages 12-1 and 12-3 is an example of the second stage. In this case, the face 12a of the stage 12-2 is an example of a first face, and the face 12a of each of the stages 12-1 and 12-3 is an example of a second face. The stages 12 may also be referred to as manufacturing tables or support tables.

The mover 13 includes a cover 70 (FIG. 1), a base 71, and supports 72, and can change postures of the individual stages 12 relative to one another with the supports 72.

The base 71 is placed in the main chamber 21 and covered with the cover 70. The base 71 has, for example, a rectangular plate shape.

The supports 72 are attached to the top face of the base 71, and at least partially covered with the cover 70. The supports 72 are provided for the respective stages 12. The supports 72 support the stages 12 and can move the stages 12 and change the postures thereof.

The supports 72 each include, for example, two link members 72a and 72b. One end of the link member 72a is swingably supported by the base 71 via the connection 72c. The link member 72a is swingably driven by a built-in motor (not illustrated) of the connection 72c. The other end of the link member 72a is connected to one end of the link member 72b so as to be relatively swingable. The link member 72b is swingably driven by a built-in motor (not illustrated) of the link member 72a or the link member 72b. The other end of the link member 72b is connected to the stage 12 via the connection 72d. The stage 12 is swingably supported by the link member 72b through the connection 72d. The stage 12 is swingably driven by a built-in motor of the connection 72d. The stage 12 is slidably driven with respect to the connection 72d in a direction crossing (for example, orthogonal to) a normal direction N of the face 12a by another built-in motor of the connection 72d. With the supports as configured above, the mover 13 can move the face 12a of the stage 12-1, the face 12a of the stage 12-2, and the face 12a of the stage 12-3 to be oriented in mutually different directions.

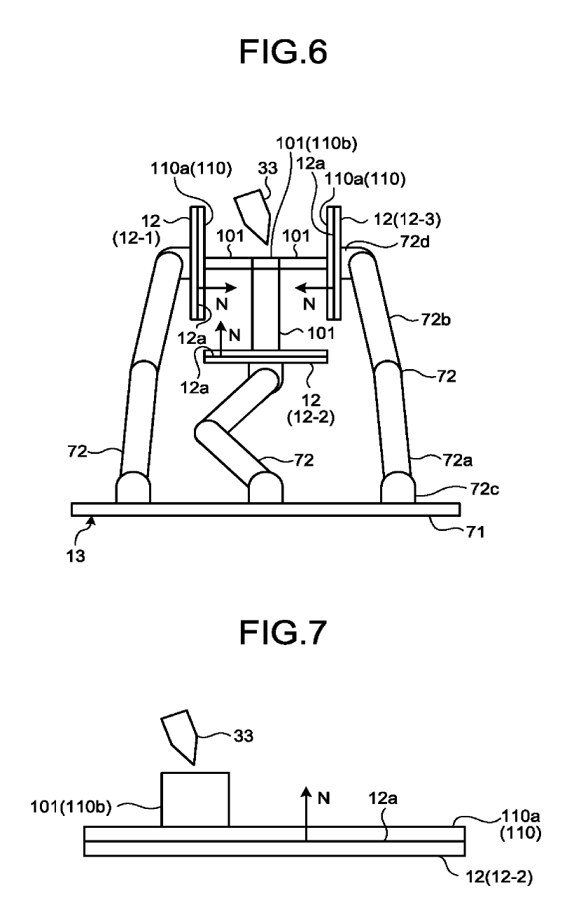

Next, an exemplary additive manufacturing method for the object 100 involving the movement of the stages 12 will be described. Herein, an additive manufacturing method for the object 100 including a protrusion illustrated in FIG. 6 will be described. FIG. 6 and other drawings omit boundary lines between the layers 110b. As illustrated in FIG. 4, the mover 13 positions the stages 12-1, 12-2, and 12-3 with the faces 12a of the stages 12-1, 12-2, and 12-3 aligned horizontally (in parallel with each other). In this state, the nozzle 33 additively forms the layers 110b in order on the faces 12a of the stages 12-1, 12-2, and 12-3 to form the object 101 thereon. Next, as illustrated in FIG. 5, the mover 13 changes the postures of the stages 12-1 and 12-3 such that the faces 12a of the stages 12-1 and 12-3 face each other above the stage 12-1, that is, the faces 12a of the stages 12-1, 12-2, and 12-3 are oriented in mutually different directions. The tip ends of the object 101 on the faces 12a of the stages 12-1, 12-2, and 12-3 approach each other. From this state, as illustrated in FIG. 6, the nozzle 33 forms a layer 110b of the material 121 in a region surrounded by (facing) the tip ends of the objects 101 to integrate the individual objects 101 on the faces 12a of the stages 12-1, 12-2, and 12-3 by the layer 110b of the material 121. In other words, the nozzle 33 forms an object 101 in the region surrounded by the tip ends of the objects 101 on the faces 12a of the stages 12-1, 12-2, and 12-3, and uses the formed object to integrate the objects 101 on the faces 12a of the stages 12-1, 12-2, and 12-3.

As described above, according to the present embodiment, the nozzle 33 forms the object 101 on each of the faces 12a of the stages 12-1, 12-2, and 12-3 which are moved by the mover 13 so that the normal direction N of the face 12a of the stage 12-2 and the normal directions N of the faces 12a of the stages 12-1 and 12-3 are aligned with each other (FIG. 4). The mover 13 then moves the stages 12-1 to 12-3 so that the normal direction N of the face 12a of the stage 12-2 is relatively inclined to the normal directions N of the faces 12a of the stages 12-1 and 12-3, that is, the faces 12a of the individual stages 12-1, 12-2, and 12-3 are oriented in mutually different directions. Then, while the faces 12a of the stages 12-1, 12-2, and 12-3 are oriented in the mutually different directions, the nozzle 33 integrates the objects 101 on the face 12a of the stage 12-2 with the objects 101 on the faces 12a of the stages 12-1 and 12-3 through the layer 110b. Thereby, the layer 110b can be inhibited from hanging at the time of forming the protrusion.

As can be seen from above, the nozzle 33 according to the present embodiment forms the layer 110b on at least one of the face 12a of the stage 12-2, the face 12a of the stage 12-1, the face 12a of the stage 12-3, the object 101 on the face 12a of the stage 12-2, the object 101 on the face 12a of the stage 12-1, and the object 101 on the face 12a of the stage 12-3, while the faces 12a of the stages 12-2, 12-1, and 12-3 are oriented in the mutually different directions. The mover 13 moves the stage 12-1 such that the face 12a (first ace) of the stage 12-2 (first stage) is oriented in a different direction from the face 12a (second face) of the stage 12-1 (second stage). Alternatively, the mover 13 may move the stage 12-2 or both the stage 12-2 and the stage 12-1 so that the face 12a of the stage 12-2 and the face 12a of the stage 12-1 are oriented in mutually different directions. That is, the mover 13 may move at least one of the stage 12-2 and the stage 12-1 such that their faces 12a are oriented in mutually different directions. Moreover, the mover 13 moves the stage 12-3 such that the face 12a (first face) of the stage 12-2 (first stage) and the face 12a (second face) of the stage 12-3 (second stage) are oriented in mutually different directions. The mover 13 may move the stage 12-2 or both the stage 12-2 and the stage 12-3 such that the face 12a of the stage 12-2 and the face 12a of the stage 12-3 are oriented in mutually different directions. That is, the mover 13 may move at least one of the stage 12-2 and the stage 12-3 such that the face 12a of the stage 12-2 and the face 12a of the stage 12-3 are oriented in mutually different directions.

Next, another exemplary additive manufacturing method for the object 100 involving the movement of the stages 12 will be described. Herein, a manufacturing method of the object including a protrusion illustrated in FIG. 9 will be described. In this example, a sheet-like base 110aA is provided on each of the faces 12a of the stages 12-1 and 12-3 instead of the base 110a. The bases 110aA are detachably attached to the faces 12a with an attachment member (attachment) such as a clamp. The bases 110aA may be made of the material 121, for example. Moreover, the bases 110aA may be, for example, a so-called support member, and has only to be made of a material that facilitates removal of the object 101 from the face 12a.

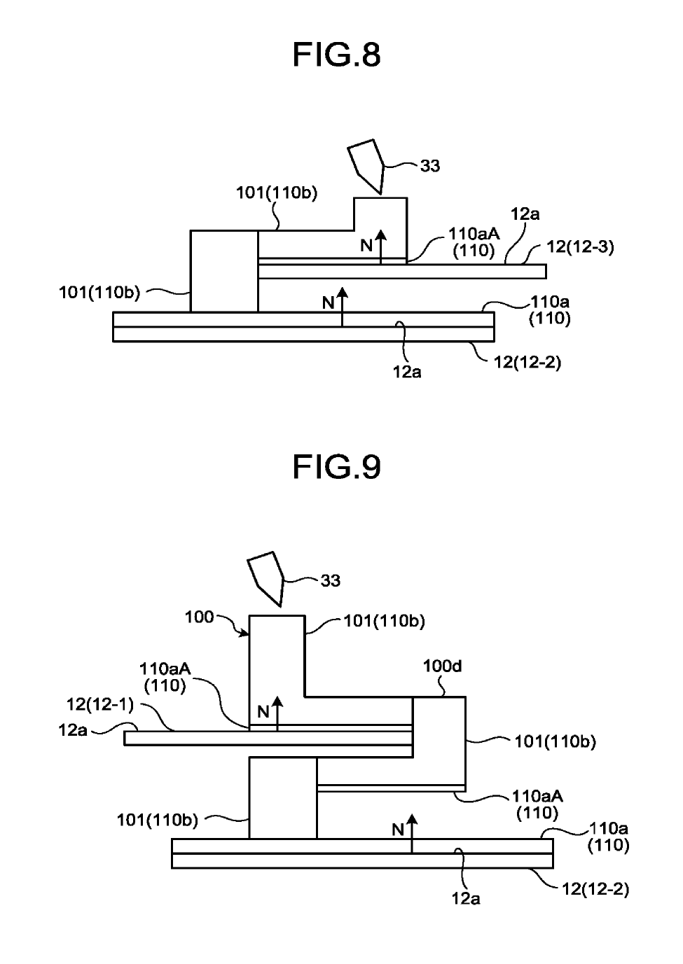

First, as illustrated in FIG. 7, the mover 13 positions the stage 12-2 such that the face 12a of the stage 12-2 becomes horizontal. In this state, the nozzle 33 additively forms the layers 110b of the material 121 to manufacture the object 101 on the face 12a of the stage 12-2. Next, as illustrated in FIG. 8, the mover 13 moves the stage 12-3 to a position above the face 12a of the stage 12-2 such that the stage 12-2 and the stage 12-3 partially overlap with each other with a space therebetween vertically. An inclination angle of the face 12a of the stage 12-3 with respect to the face 12a of the stage 12-2 is set in accordance with a protruding direction of the object 101 on the face 12a of the stage 12-2. That is, while FIG. 8 illustrates an example of parallel setting of the face 12a of the stage 12-3 and the face 12a of the stage 12-2, the face 12a of the stage 12-3 may be inclined with respect to the face 12a of the stage 12-2. The nozzle 33 then forms a layer 110b of the material 121 on the face 12a of the stage 12-3 so as to continue with the object 101 on the face 12a of the stage 12-2 to form the object 101 on the face 12a of the stage 12-3. The object 101 on the face 12a of the stage 12-3 protrudes from the object 101 on the face 12a of the stage 12-2.

Next, the mover 13 retracts the stage 12-3 from above the stage 12-2 (FIG. 9). The base 110aA is then removed from the face 12a of the stage 12-3, while remaining attached to the object 101.

Next, as illustrated in FIG. 9, the mover 13 moves the stage 12-1 to a position above the face 12a of the stage 12-2 such that the stage 12-1 and the stage 12-2 partially overlap with each other with a space therebetween vertically. An inclination angle of the face 12a of the stage 12-1 with respect to the face 12a of the stage 12-2 is set in accordance with a protruding direction of the object 101 on the face 12a of the stage 12-3. That is, while FIG. 9 illustrates an example of parallel setting of the face 12a of the stage 12-1 and the face 12a of the stage 12-2, the face 12a of the stage 12-1 may be inclined with respect to the face 12a of the stage 12-2. Next, the nozzle 33 forms the layer 110b of the material 121 on the face 12a of the stage 12-3 in continuation with the object 101 on the stage 12-3 to form the object 101 on the face 12a of the stage 12-1. The object 101 on the face 12a of the stage 12-1 protrudes from the object 101 on the stage 12-3. Next, the mover 13 retracts the stage 12-1 from above the stage 12-2. The base 110aA is then removed from the face 12a of the stage 12-1, while remaining attached to the object 101. In this manner, the object 100 is additively manufactured, and the base 110aA can be removed from the manufactured object 100 at a predetermined stage. The base 110aA may be used in the additive manufacturing method for the object 100 described in FIGS. 4 to 6, for example.

As described above, according to the present embodiment, the nozzle 33 forms the layer 110b on at least one of the face 12a of the stage 12-2, the face 12a of the stage 12-1, the face 12a of the stage 12-3, the object 101 on the face 12a of the stage 12-2, the object 101 on the face 12a of the stage 12-1, and the object 101 on the face 12a of the stage 12-3, while the face 12a (first face) of the stage 12-2 (first stage) and the faces 12a (second face) of the stages 12-1 and 12-3 (second stages) are oriented in mutually different directions. Thus, for example, for forming the object 100 including the protrusion, it is possible to inhibit the layer 110b from hanging and therefore form the layer 110b efficiently.

According to the present embodiment, the nozzle 33 integrates the object 101 on the face 12a of the stage 12-2 with the objects 101 on the faces 12a of the stages 12-1 and 12-3 through the layer 110b, while the face 12a (first face) of the stage 12-2 (first stage) and the faces 12a (second face) of the stages 12-1 and 12-3 (second stages) are oriented in mutually different directions. Accordingly, it is possible to form parts (object 101) of the object 100 on the individual stages 12-1, 12-2, and 12-3 and to integrate them.

Moreover, according to the present embodiment, the mover 13 changes the relative posture of the stage 12-2 (first stage) and the stages 12-1 and 12-3 (second stages). For example, it is possible to change the relative posture of the stage 12-2 and the stages 12-1 and 12-3 in accordance with the shape of the object 100.

### Second Embodiment

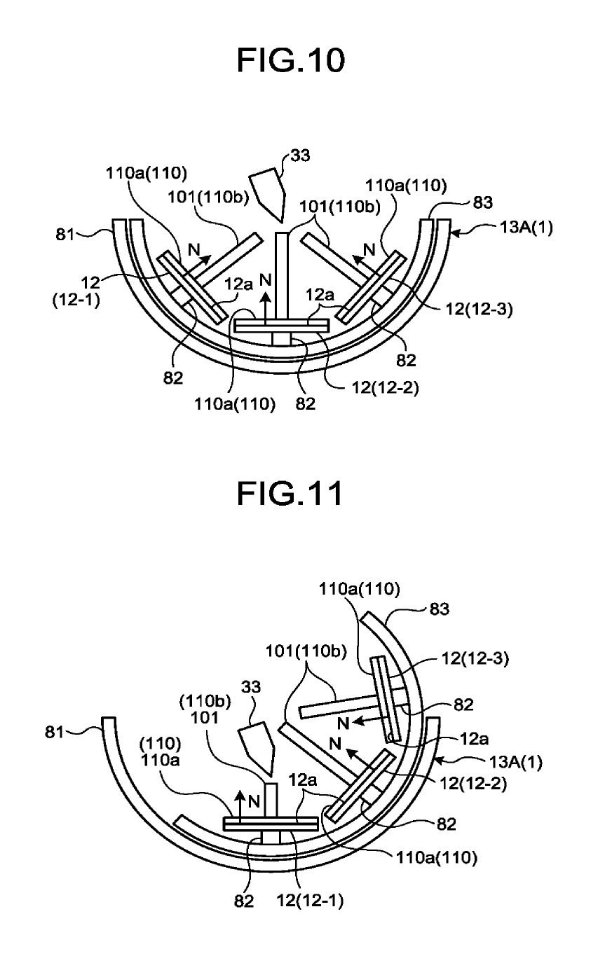

As illustrated in FIGS. 10 to 13, the present embodiment differs mainly in a mover 13A from the first embodiment. The mover 13A according to the present embodiment swings the individual stages 12, arranged with the faces 12a oriented in mutually different directions, in the direction of the arranged stages 12.

The mover 13A includes a base 81, supports 82, and a swing part 83. The base 81 has a curved, arc shape. The swing part 83 has a curved, arc shape along the base 81, and is positioned inside the base 81. The swing part 83 is swingably supported by the base 81. The swing part 83 is driven by a motor (not illustrated) to swing along the base 81. The base 81 functions as a guide (rail) for guiding the swing part 83. Moreover, according to the present embodiment, the stages 12-1, 12-2, and 12-3 are arranged in a row along the swing part 83.

The supports 82 are positioned opposite the swing part 83 in the base 81, that is, inside the swing part 83, and is supported by the swing part 83. The supports 82 are provided for the respective stages 12. The supports 82 are extensible and contractible, and move the corresponding stages 12 in the normal directions N of the faces 12a. That is, the mover 13A can individually move the stages 12-1, 12-2, and 12-3 in the normal directions N of the faces 12a of the stage 12-1, 12-2, and the stage 12-3.

Next, an exemplary additive manufacturing method for the object 100 involving the movement of the stage 12 will be described. Herein, an additive manufacturing method of the object 100 including a protrusion illustrated in FIG. 13 will be described. First, as illustrated in FIG. 11, the mover 13A controls the swing 83 so as to horizontally place the face 12a of the target stage 12 on which the object 101 is (currently) to be formed. Then, the nozzle 33 additively forms the layers 110b on the face 12a of the target stage 12 to form the object 101. FIG. 11 illustrates that the objects 101 has already been formed on the stages 12-2 and 12-3 and the object 101 is being formed on the stage 12-1. In this manner, the objects 101 are formed in order on the stages 12-1, 12-2, and 12-3.

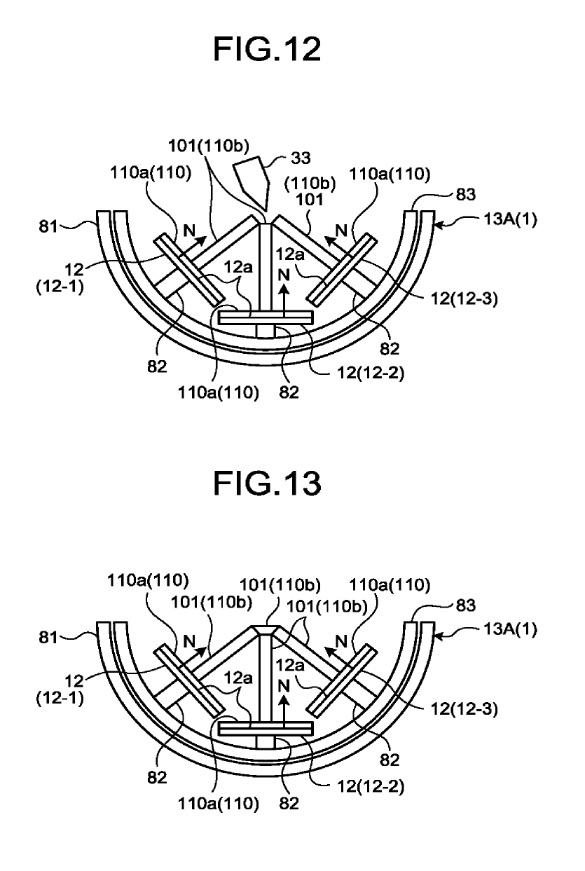

Next, as illustrated in FIG. 12, the mover 13A controls the swing part 83 to horizontally place the face 12a of the stage 12-2, and pushes up (moves) the stages 12-1 and 12-3 in the normal directions N of the faces 12a away from the swing part 83. From this state, the nozzle 33 forms a layer 110b (object 101) of the material 121 in a region surrounded by the tip ends of the objects 101 on the faces 12a of the stage 12-1, 12-2, and 12-3, and integrates the objects 101 on the faces 12a of the individual stages 12-1, 12-2, and 12-3 (FIG. 13) through the layer 110b of the material 121. As described above, according to the present embodiment, the nozzles 33 forms the objects 101 on the individual faces 12a of the stage 12-1, 12-2, and the stage 12-3. Then, the nozzle 33 integrates the object 101 on the face 12a of the stage 12-2 with the objects 101 on the faces 12a of the stages 12-1 and 12-3 by the layer 110b after the mover 13A relatively moves the stage 12-2 and the stages 12-1 and 12-3 so that the object 101 on the face 12a of the stage 12-2 and the objects 101 on the faces 12a of the stages 12-1 and 12-3 approach each other.

As can be seen from the above, the nozzle 33 according to the present embodiment forms the layer 110b on at least one of the face 12a of the stage 12-2, the face 12a of the stage 12-1, the face 12a of the stage 12-3, the object 101 on the face 12a of the stage 12-2, the object 101 on the face 12a of the stage 12-1, and the object 101 on the face 12a of the stage 12-3, while the face 12a of the stage 12-2 and the faces 12a of the stages 12-1 and 12-3 are oriented in mutually different directions.

According to the present embodiment described above, the nozzle 33 forms the layer 110b on at least one of the faces 12a of the stages 12-2, 12-1 and 12-3, and the objects 101 on the faces 12a of the stage 12-2, 12-1, and 12-3, while the face 12a (first face) of the stage 12-2 (first stage) and the faces 12a (second face) of the stages 12-1 and 12-3 (second stages) are oriented in mutually different directions. Thus, for example, for forming the object 100 having the protrusion, the layer 110b is inhibited from hanging and can thus be efficiently formed.

Moreover, according to the present embodiment, the mover 13A swings the stage 12-2 together with the stages 12-1 and 12-3 in the arranged direction thereof, in which the face 12a (first face) of the stage 12-2 (first stage) and the faces 12a (second face) of the stages 12-1 and 12-3 (second stages) are oriented in mutually different directions. It is thus possible to change the orientation of the faces 12a of the stages 12-1, 12-2, and 12-3 by swinging.

While several embodiments of the invention have been described, these embodiments have been presented by way of example and are not intended to limit the scope of the invention. These novel embodiments can be implemented in various other forms, and various omissions, substitutions, and modifications can be made without departing from the spirit and scope of the invention. These embodiments and modifications thereof are included in the scope and spirit of the invention, and are included in the invention described in the appended claims and the equivalent thereof.

For example, in the configurations illustrated in FIGS. 4 and 10, the stage 12-2 may be omitted and the objects 101 may be formed on the stage 12-1 and the stage 12-3. In this case, one of the stage 12-1 and the stage 12-3 corresponds to the first stage, and the other corresponds to the second stage.

For another example, in the configuration illustrated in FIG. 10, the stage 12-2 may be omitted, and it is not necessary to connect the two objects 101 created on the stages 12-1 and 12-3 which are fixed in the state illustrated in FIG. 10. That is, each of the objects 101 may be a finished product. In this case, multiple objects can be more efficiently manufactured than when the object 101 is manufactured on one stage multiple times. In this case, the inclination angle of each of the stage 12-1 and the stage 12-3 can be set to such a degree that can avoid the layer 110b from hanging.

1. A additive manufacturing apparatus comprising:
a first stage including a first face;
a second stage including a second face; and
a nozzle that forms a layer of a material on at least one of the first face, the second face, an object on the first face, and an object on the second face, while the first face and the second face are oriented in mutually different directions.

2. The additive manufacturing apparatus according to claim 1,
wherein the nozzle integrates the object on the first face with the object on the second face, while the first face and the second face are oriented in mutually different directions.

3. The additive manufacturing apparatus according to claim 1, further comprising a mover that changes a relative posture of the first stage and the second stage.

4. The additive manufacturing apparatus according to claim 3,
wherein the nozzle forms the object on each of the first face and the second face of which normal directions are made aligned with each other by the mover, and integrates the object on the first face with the object on the second face by the layer, while the normal direction of the first face and the normal direction of the second face are relatively inclined with respect to each other by the mover.

5. The additive manufacturing apparatus according to claim 1, further comprising a mover that swings the first stage and the second stage in an arranged direction of the first stage and the second stage, the first and second stages being arranged with the first face and the second face oriented in mutually different directions.

6. The additive manufacturing apparatus according to claim 5,
wherein the mover moves at least one of the first stage and the second stage in a normal direction of the first face and in a normal direction of the second face, respectively.

7. The additive manufacturing apparatus according to claim 6,
wherein the nozzle forms the object on each of the first face and the second face, and integrates the object on the first face with the object on the second face by the layer after the first stage and the second stage are relatively moved with respect to each other by the mover such that the object on the first face and the object on the second face approach each other.

8. An additive manufacturing apparatus comprising:
a first stage including a first face;
a second stage including a second face;
a nozzle that forms a layer of a material on at least one of the first face and the second face; and
a mover that moves at least one of the first stage and the second stage such that the first face and the second face are oriented in mutually different directions.

9. An additive manufacturing method comprising:
moving, by a mover, at least one of a first stage including a first face and a second stage including a second face; and
forming, by a nozzle, a layer of a material on at least one of the first face, the second face, an object on the first face, and an object on the second face, while the first face and the second face are oriented in mutually different directions.

10. An additive manufacturing method comprising:
forming an object on a first face of a first stage;
forming an object on a second face of a second stage; and
moving at least one of the first stage and the second stage to join the object formed on the first face with the object formed on the second face.
